(19) United States
(12) Patent Application Publication
(10) Pub. No.: US 2009/0300550 A1
(43) Pub. Date: Dec. 3, 2009

(54) Method and Device for Assisting Users in Reporting Health Related Symptoms and Problems

(75) Inventor: Cornelia Ruland, Oslo (NO)

Correspondence Address: KNOBBE MARTENS OLSON & BEAR LLP, 2040 MAIN STREET, FOURTEENTH FLOOR, IRVINE, CA, 92614, US

(73) Assignee: RIKSHOSPITALET-RADIUMHOSPITALET HF, Oslo (NO)

(21) Appl. No.: 12/227,098

(22) PCT Filed: May 10, 2007
(86) PCT No.: PCT/NO2007/000169

§ 371 Date: Aug. 3, 2009

(30) Foreign Application Priority Data
May 10, 2006 (DK) PA 2006 00666

(51) Int. Cl. G06F 3/048; G06F 3/041

(52) U.S. Cl. 715/841; 345/173

(57) ABSTRACT

The present invention discloses a device, a method and software for mapping health related symptoms and problems with the aim of collecting and structuring information related to sick person's health related symptoms and problems. A device is disclosed which comprises hardware and a graphical user interface (GUI) for user interaction. The device also comprises software implementing an interactive questionnaire for graphically presenting health related symptoms and problems to a user and registering the user's response via the GUI, as well as software implementing a report generator for generating a report that maps health related symptoms and problems based on the response from the user.

### FIELD OF THE INVENTION

The present invention relates to collecting and structuring information related to sick person's health related symptoms and problems.

### BACKGROUND OF THE INVENTION

Children diagnosed with serious physical, functional, mental, social, or behavioral problems, and chronic or serious long term illnesses (e.g. cancer) are generally very vulnerable. They may suffer from a lack of emotional and cognitive maturity and life experience that could equip them with the ability to cope with, and make sense of, the many complex physical, functional, psychosocial and behavioral problems associated with the illness. To help the children and prevent unnecessary suffering, health care providers need to understand children's symptoms and problems from the children's own perspective. This can be difficult because children vary widely in their illness experiences.

Furthermore, less developed verbal skills, adults' communication styles and attitudes to speak on their child's behalf may prevent children from conveying distressing symptoms to their care providers. Recent work has shown that clinicians often are unaware of symptoms and problems experienced by pediatric patients, so that many symptoms remain under-diagnosed or untreated.

Likewise, also physically or psychically impaired persons may suffer from problems with respect to conveying health related symptoms and problems to a care provider.

Systems for assessing symptoms for children, speech Impaired or foreign language speaking adults exist, e.g. U.S. Pat. No. 6,339,410, U.S. Pat. No. 6,314,405, U.S. Pat. No. 5,720,502 or WO 06/024838. Such systems heavily rely on the user's motivation and honesty to confront the facts, understanding when a psychological and physical state is abnormal, as well as ability to transfer the states to an abstract form such as a questionnaire or a table. In the case of children, the assistance of an adult is needed to read and understand the context and fill in replies. This introduces risks of the adult's misinterpretation of the context as well as the child's response, incompleteness' due to limitations in child's language skills, and possible inhibitions in the child to communicate openly.

### SUMMARY OF THE INVENTION

It is an object of the present invention to provide a device, method and software to assist in collecting a user's or patient's health related symptoms and problems, wherein the user or patient itself interacts and responds directly. The invention may help to communicate symptom experiences to care providers. For a child user, this may be done in a child-friendly, age-adjusted manner. At the same time, the invention provides assistance to clinicians to appropriately address symptoms and problems experienced by a patient, tailored to individual needs.

In a first aspect, the invention provides a device for mapping health related symptoms and problems, the device comprising:
a memory;
an electronic processor;
a display;
a graphical user interface (GUI);
a pointing device for user interaction via the GUI;
software implementing an interactive questionnaire for presenting health related symptoms and problems to a user and registering the user's response via the GUI,
   the interactive questionnaire being configured to graphically present and perform a main character and a storyline, wherein the storyline consists of a number of categories related to at least physical health, mental health, and everyday life, and wherein the main character can be controlled to go through the storyline by the user;
software implementing a report generator for generating a report that maps health related symptoms and problems based on the response from the user.

The user is typically a child, however the invention may also beneficially be used with a physically or psychically impaired person.

The memory and the electronic processor may be configured to hold and execute software and for collecting and storing user responses. However, network-based solutions where the software to be executed and the collected responses are stored on a central server are also possible. The device may also comprise a database containing the system's knowledge base and graphical elements.

The device is intended for use by the user itself. In the situation where the user is a child, the use may depend on the child's age and state. The child may use the device alone (typically if above the age of six), or alternatively under guidance of an adult care provider.

In an exemplary embodiment, the display and the pointing device is provided by a touch sensitive display. Also, the device may further comprise a battery pack, rendering the device fully portable, so that it may be used in any environment, e.g. at the hospital bed, at home, in school, or at a doctors or psychologist's office etc. In an exemplary embodiment, the device may be a computer such as a laptop or a PDA (personal digital assistant) running the specified software, or it may be a dedicated device designed for this specific use. The GUI will typically be part of the interactive questionnaire software.

Health related symptoms and problems may be any condition, state, emotion or fact related to the user's or patient's well-being, including possible side-effects from a treatment. Symptoms and problems need not be directly related to the illness or potential diagnosis of the user or patient. The collected symptoms and problems is intended to assist a care provider in providing a basis for diagnosing the patient, a basis which may be used for approaching the patient with important issues, as well as to obtain an indication of the patient's physical and mental health.

In a second aspect, the invention provides a software program for mapping health related symptoms and problems, to be executed on an electronic processing device with a display, a pointing device and a graphical user interface (GUI). The software program may implement the interactive questionnaire and the report generator of the device according to the first aspect.

In either of the first and second aspect the interactive questionnaire presents a storyline featuring a main character with whom the user or patient identifies. Some characteristics of the main character, such as gender, age, race etc., may therefore be chosen to resemble the user or patient itself or a character that the user or patient easily connects with.

In the present context, presenting something graphically refer to drawings, photographs figures, animations or moving pictures. Something written in text only does not represent a graphical presentation in the present context. In an exemplary embodiment, the graphical presentation of the main character and the storyline are performed as animated drawings.

The categories of the storyline provide structure the questionnaire, and may be presented as different situations to which the user or patient easily relates. The storyline may bind the different categories together in almost any way, e.g. as a voyage to different destinations representing categories to provide a sense of adventure; as the course of a normal day with categories taking place at different hours to provide a recognizable and chronological order of events; or as a fairytale in which the main character encounter persons representing categories. The questionnaire is interactive meaning that the user or patient can control how to navigate and access different parts of through the storyline.

The categories are entries to collect information of symptoms and problems within different fields including, but not limited to physical health, mental health, and everyday life. Additional categories may depend on the intended use, an additional category being e.g.
“Hospitalization” for children at hospitals or other observation institutions or clinics, or
“Managing the crisis” for children having been through serious abuse or other crisis.

The interactive questionnaire may be further configured to:
in each category, graphically present the main character in one or more scenes, each scene presenting a number of potential health related symptoms and/or problems;
provide a graphical object for each potential health related symptom or problem;
for each said graphical object, provide a link to an explanatory illustration of the symptom or problem and a response option allowing the user to select a degree to which the symptom or problem is relevant; and
register each selection made by the user.

Different examples of categories, scenes, potential health related symptoms and/or problems, graphical objects, explanatory illustration and response options will be given in relation to the detailed description and the figures. For the purpose of understanding, a simple example will be given here: In a category from the main character's everyday life, one scene is a classroom in which two potential health related symptoms or problems are related to concentration and writing. The graphical object for the concentration problem is a calculation on a blackboard, and the graphical object for the writing problem is pen and paper. When the user or patient clicks on the pen and paper object, the user or patient is presented with an explanatory illustration showing the main character writing with a poor result. A voice or a text may present a statement such as “difficult in writing”, and a number of emoticons appear as response options ranging from a sad face to a smiley. The user's or patient's response in the form of selection of an emoticon is registered.

The graphical object need not be logically related to the problem. As an example, children are well accustomed to explore scenes to find selectable objects from computer games and other programs. However, the explanatory illustration lead to by the graphical object explains the symptom or problem to at least some degree, possibly assisted by voice or text. The explanatory illustration may be animated.

The term questionnaire does not indicate that the explanatory illustrations necessarily ask a question although it may do so. It may also present a statement or condition with which the user or patient can agree to, to a selected degree, or illustrate different versions of the same symptom or problem between which the user or patient selects. Similarly, the response options may take different forms depending of the nature of the explanatory illustrations of the symptom or problem. The response options for some symptoms or problems may allow the user or patient to select different replies (e.g. yes/no), for others the selection may be different degrees of agreement (a scale), degree of severity or annoyance, and others the selection may be between different symptoms or problems of the same type. In the present context, the expression of whether the presented symptom or problem is relevant is intended to cover all of the above types of response from the user or patient.

In an exemplary embodiment, the report generator is configured to present the registered responses in a report. The report lists connected categories, symptoms and problems, and user responses. The report may be obtained by activating the report generator, and is intended for use by a care provider such as a nurse, a medical doctor or a psychologist, but also by the user or patient to help them communicate about their problems. The report is may be presented in writing in a table, possibly with some illustrating graphics, and in a format which enables interface with medical record administration systems. The report may thereby provide a mapping or a summary of the user's or patient's physical and mental state.

In order to monitor the development of the user's or patient's health, the device and software may be configured to track trends in the user's or patients response over time, by repeated use of a software implementation of embodiments of the present invention. To this purpose, the memory and electronic processor may store and recall previous responses from the user or patient, and the report generator software may generate a report of the development of the user's or patient's responses to symptoms and/or problems over time.

In an alternative formulation of the first aspect, the invention can be described as a device that represents
1. an interactive, visual assessment tool for elicitation of symptoms and problems from the perspective of the user or patient;
2. a communication tool to help a user or patient to verbalize and communicate about their symptoms and problems with professional helpers (e.g. health care providers, psychologists, social/school workers)
3. a clinical decision support tool to assist professional helpers in providing patients with individually tailored care and support.

In a third aspect, the invention provides a method for mapping health related symptoms and problems, the method is to be carried out on an electronic processing device with a display, a pointing device and a graphical user interface (GUI), the method comprising the steps of:
graphically presenting and performing a main character and a storyline consisting of a number of categories related to at least physical health, mental health, and everyday life, wherein the main character is controlled to go through the storyline by a user via the GUI;
presenting potential health related symptoms and problems in each category and allowing the user to respond the presented symptoms and problems via the GUI; and
presenting the response from the user to the presented symptoms and problems in a report, the report listing connected categories, symptoms and/or problems, and response.

The method thus covers the actions performed when using the device or software program according to the first and second aspects. Features presented in relation to these may also apply to the method where appropriate. Correspondingly, the method may further comprise the steps of:
in each category, graphically presenting the main character in one or more scenes, each scene presenting a number of potential health related symptoms and/or problems;
for each potential health related symptom or problem, presenting a graphical object for the symptom or problem;
linking each graphical object to an explanatory illustration of the symptom or problem and a response option allowing the user or patient to respond with a degree to which the symptom or problem is relevant.

One of the basic ideas of the invention is to present the potential symptoms and problems in a context that is immediately recognizable by the user or patient without interpretation or translation by another person. Another one of the basic ideas is to allow the user or patient itself to respond directly via the GUI, without the mediation of somebody else. These features are believed to provide a more complete, open minded and true response, which is experienced by the user or patient as a captivating communication rather than a medical examination.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows an optional opening sequence where appearance of the main character can be selected.

FIG. 2 shows the graphical presentation of the categories of the storyline according to an exemplary embodiment of the invention.

FIGS. 3A-D are detailed views of the graphical presentation of some of the categories from FIG. 2.

FIG. 4 is a scene from the category of FIG. 3A.

FIGS. 5A-C are explanatory illustrations of symptoms or problems linked to objects in the scene of FIG. 4.

FIG. 6 is a scene from the category of FIG. 3B.

FIGS. 7A-C are explanatory illustrations of symptoms or problems linked to objects in the scene of FIG. 6.

FIG. 8 is a scene from the category of FIG. 3C.

FIGS. 9A-C are explanatory illustrations of symptoms or problems linked to objects in the scene of FIG. 8.

FIG. 10 shows the scene of FIG. 8 after all symptoms and problems have been explored.

FIG. 11 shows the link to activating the report generator in the graphical presentation of FIG. 2.

FIGS. 12A and B illustrates a device according to an exemplary embodiment of the first aspect of the invention.

FIG. 13 illustrates the software program according to an exemplary embodiment of the second aspect of the invention.

FIG. 14 illustrates a report directed to a child.

FIGS. 15A and 15B shows an embodiment of the device according to the invention and a typical hardware layout for an embodiment.

FIG. 16 illustrates the layout of the interactive questionnaire according to an embodiment of the invention.

### DESCRIPTION OF EMBODIMENTS

Firstly, a comprehensive description of the storyline and subordinate elements of the interactive questionnaire will be given in relation to an exemplary embodiment of the invention. This description demonstrates the method according to the third aspect, as well as the use of the device and software according to the first and second aspects. Thereafter, a detailed description of the device and software according to the first and second aspects will be given.

It is emphasized that the description of the interactive questionnaire is presented in relation to an exemplary embodiment which includes optional elements that are not essential to the invention.

The Figures illustrates embodiments of the present invention which are directed to a child. It is however to be understood, that the present invention, while it may advantageously be applied to a child user, it is not limited to a user of a certain age.

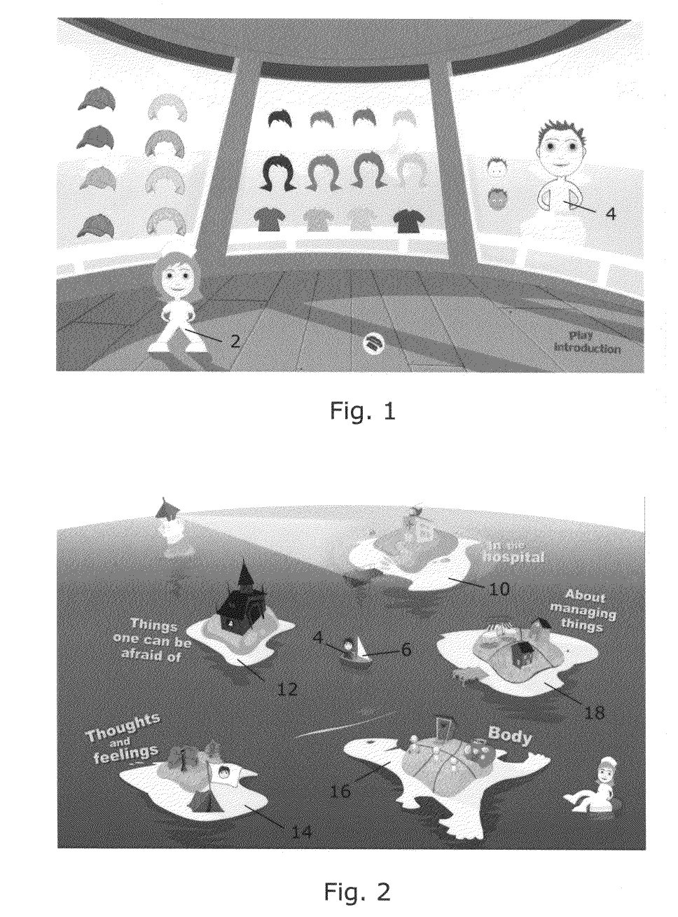

FIG. 1 illustrates an optional opening sequence, where a host figure, here nurse 2, introduces the child and guides the child in selecting the appearance of the main character 4. By clicking on various clothing articles and personal characteristics such as hair or skin color, the child designs the main character as a figure it can identify with, e.g. an image of itself.

FIG. 2 is a graphical presentation of the categories of the storyline according to an exemplary embodiment of the invention. In the embodiment, the storyline is an adventurous voyage made by the main character 4, on which he/she explores a number of islands (10, 12, 14, 16, and 18) by sailboat 6. The appearance of each island reflects a category according to the invention, and may be scored with text. In FIG. 2, the themes of the islands and the corresponding categories are:
Island 10: In the hospital—mental and physical health category and everyday life category
Island 12: Things that one can be afraid of—mental health category
Island 14: Thoughts and feelings—mental health and everyday life category
Island 16: About the body—physical health category
Island 18: About managing things—mental health, everyday life and physical health category
   Clinking on an island trigger the main character to sail to and disembark on the island.

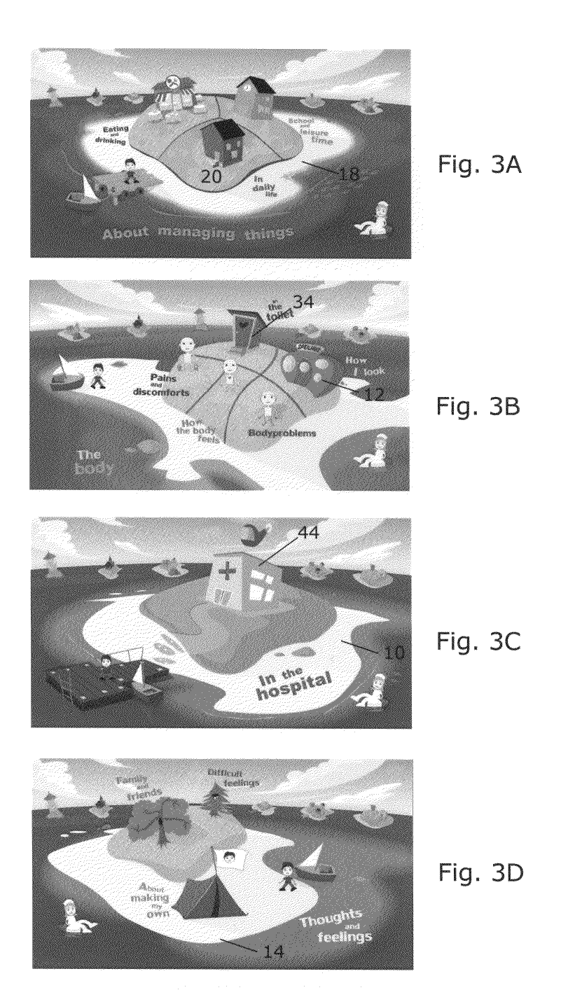

FIGS. 3A-D show detailed views of the graphical presentation of the islands denoted 18, 16, 10 and 14, respectively. Islands 14, 16 and 18 are divided into different scenes representing subordinate subjects to the theme of the category, whereas island 10 presents only a single scene, namely the hospital. Each scene is illustrated and optionally scored, and clicking on the scene causes the main character to enter the scene.

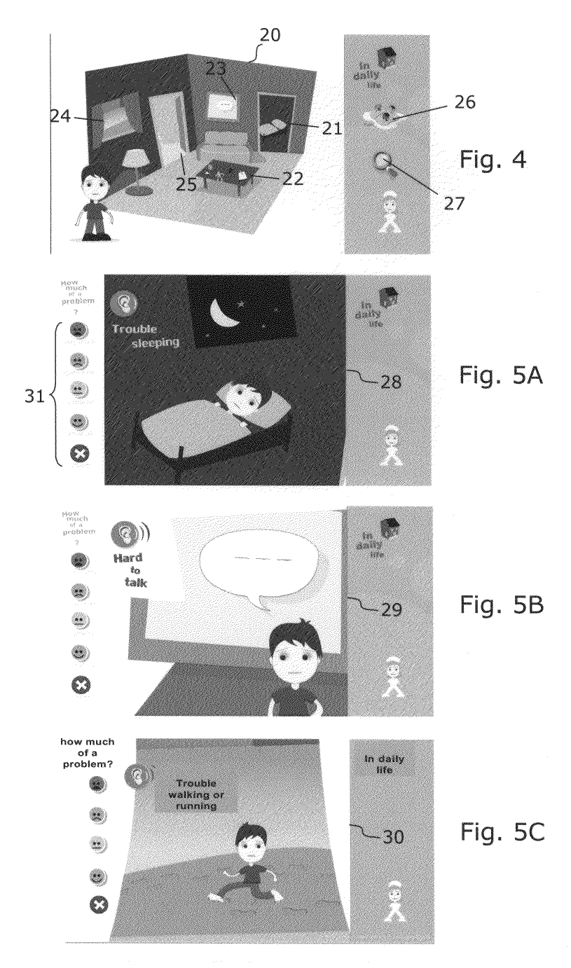

FIG. 4 is a graphical presentation illustrating that the main character has entered the scene 20 scored “Everyday life” from island 18 of FIG. 3A. Scene 20 present a number of graphical objects 21-25 which can be selected. Clicking the magnifying glass 27 will highlight clickable objects in the scene.

FIGS. 5A-C show explanatory illustrations 28, 29 and 30 of symptoms or problems lead to by objects 21, 23 and 24 in the scene 20 of FIG. 4. Each explanatory illustration conveys a symptom or a problem experienced by the main character. Explanatory illustration 28 of FIG. 5A presents the problem “Trouble sleeping at night” which may be scored or voiced in addition. To the left of the explanatory illustration, a response option is shown, which allows the child to respond with the degree to which this is a problem. Here, the response option is a scale 31 of emoticons expressing different degrees of how the child feels about the presented symptom or problem, including an “unsure” option marked by an x.

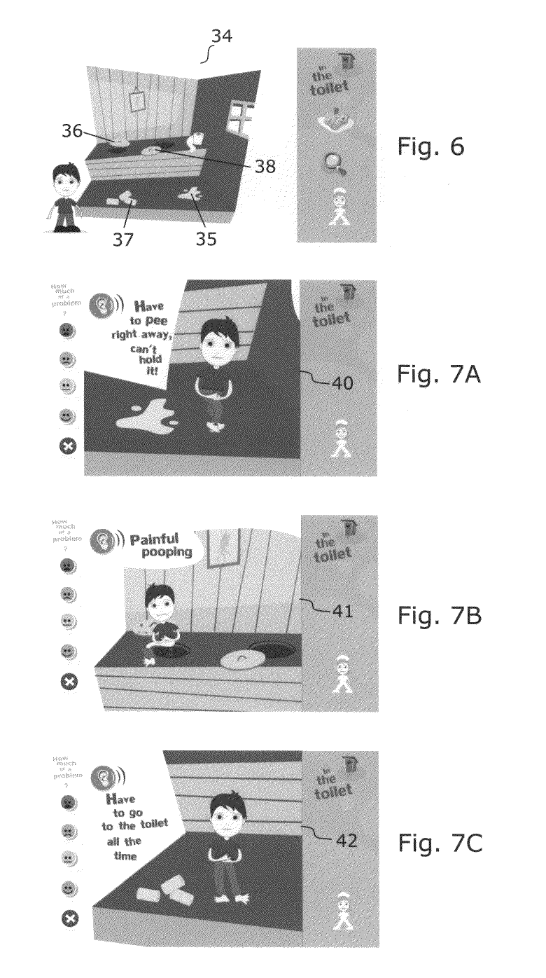

In a similar fashion, FIG. 6 shows a scene 34 from the island 16 of FIG. 3B. A number of selectable objects 35-38 are shown in the scene.

FIGS. 7A-C show explanatory illustrations 40, 41 and 42 of symptoms or problems lead to by objects 35, 36 and 37, respectively.

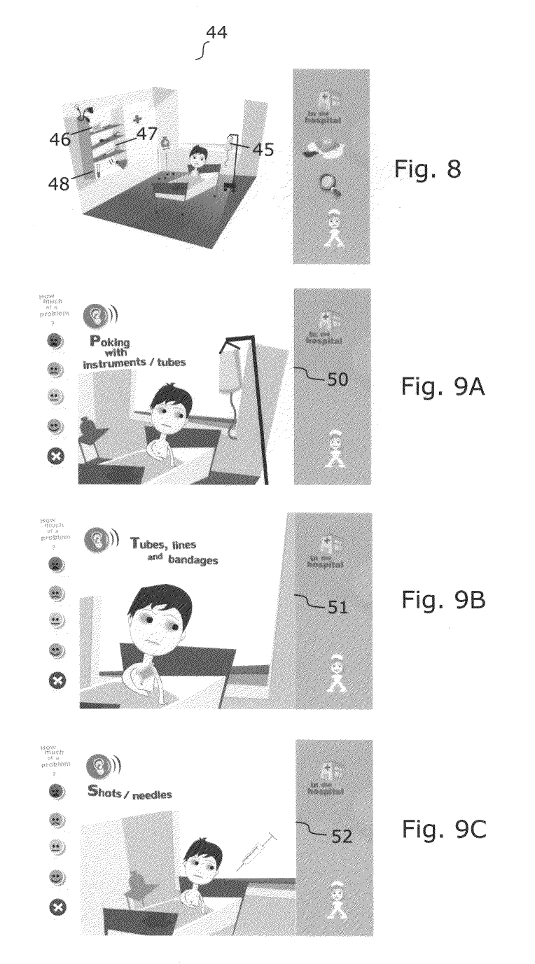

Also, FIG. 8 shows a scene 44 from the island 10 of FIG. 3C. A number of selectable objects 45-48 are shown in the scene. FIGS. 9A-C show explanatory illustrations 50, 51 and 52 of symptoms or problems lead to by objects 45, 46 and 47, respectively.

Table 1 below presents an overview of the categories, scenes and symptoms and problems used in the current example.

TABLE 1

| | |
|---|---|
| Scene | Symptom/problem |

Category: About the Body

| | |
|---|---|
| Pains and discomforts | Itching |
| | Hurts |
| | Bruises |
| | Bleeding |
| | Rash/red spots |
| Body problems | Trouble breathing |
| | Stuffy nose |
| | Mucus in the throat/yucky throat |
| | Nose bleed |
| | Things smell bad or disgusting |
| | Cough |
| | Shaky hands |
| | Trouble walking or running |
| | Trouble hearing |
| | Trouble seeing |
| | Heart running fast/Palpitations |
| How I look | Growing body- or facial hair |
| | Bald/No hair |
| | Gaining weight |
| | Swollen body |
| | Skinny/Losing weight |
| In the toilet | Have to pee right away, can't hold it |
| | Painful peeing |
| | Painful pooping |
| | Cannot poop |
| | Have to go to the toilet all the time |
| | Runny poop/diarrhea |
| | Farting a lot |
| How the body feels | exhausted |
| | Sleepy all the time |
| | Feel sick to stomach/Nausea |
| | Chills |
| | Hot or sweaty |
| | Throwing up |
| | Dizzy |
| | Pins and needles/tingling |
| | Feeling clumsy |
| | Confused |

Category: About managing things

| | |
|---|---|
| In daily life | Trouble sleeping |
| | Cannot relax |
| | Trouble doing something for more than a |
| | short while |
| | Need help bathing/dressing |
| | Hard to tell others how I feel |
| | Hard to talk |
| School and leisure time | Cannot follow when others speak |
| | Cannot do things on my own |
| | Forgetting things |
| | Feeling bored |
| | Trouble reading and writing |
| | Not learning as much as the others in school |
| | Trouble concentrating |
| Eating and drinking | Feeling thirsty a lot |
| | Cannot eat |
| | Cannot drink |
| | Always hungry |
| | Things taste different |

Category: Thoughts and feelings

| | |
|---|---|
| Family and friends | Thinking others are sad because of me |
| | Thinking I'm to blame for being sick |
| | Trouble with my friends |
| | Feeling different from other children |
| | Missing my family and friends |
| Difficult feelings | Tired of talk and nagging about things |
| | Feeling alone |
| | Feeling childish |
| | Angry |
| | Sad |
| | Embarrassed |
| | Crying a lot |
| | Feeling stupid |
| | Nothing is fun any more |
| About making my own | Don't know what I want |
| decisions | Not allowed to do what other kids do |
| | Want to be alone |
| | Wondering what it will be like going home |
| | Not being allowed to make any decisions |
| | Not being told things I wonder about |
| | Never getting things the way I want them |
| Things one can be afraid of | Painful things in the hospital |
| | Getting infections |
| | That my hair won't grow back |
| | That the treatment will make me more ill |
| | Being alone |
| | That the cancer will return when I'm older |
| | That one can die from cancer |
| | I am afraid |
| | Nightmares |
| What is difficult about | Trouble taking medicines |
| treatment | Getting treatment |
| | Removing stitches |
| | Having tubes and lines |
| | Sticking me for blood |
| | Taking blood pressure |
| | Tubes, lines and bandages |
| | Putting me to sleep |
| | Removing band aids |
| | Poking with instruments/tubes |
| | Shots/needles |

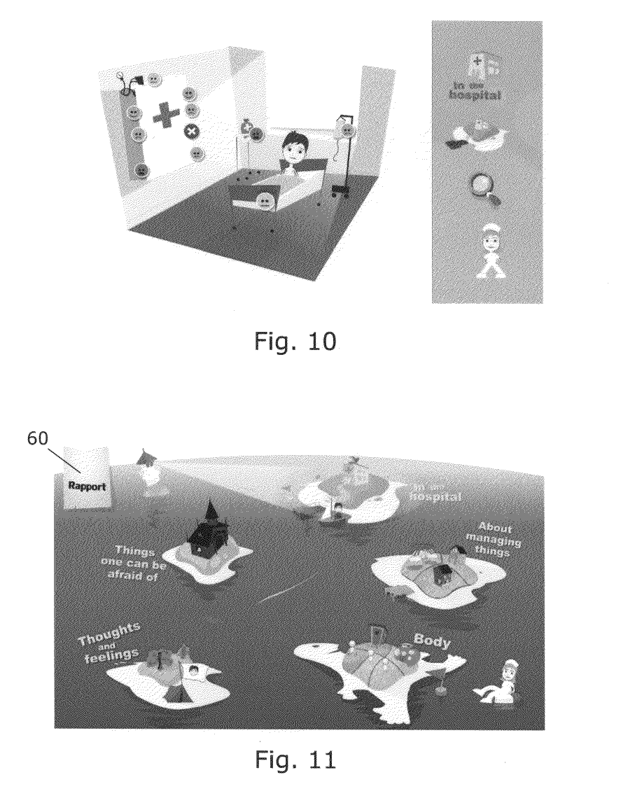

As shown in FIG. 10, after the child has responded to an explanatory illustration linked to by a scene, the corresponding object may optionally be marked with the selected emoticon. This provides an overview of which symptoms and problems have been covered so far. When the child is done with an island or section on the island, it turns green. This indicates to the child how far it is has proceeded on the journey, and which parts that are still left to visit.

When the child has responded to a predetermined number of symptoms and problems, it is possible to generate a set of comprehensible reports on the condition of the child. As shown in FIG. 11, the report generator can display an icon 60 at the display which presents the report when selected.

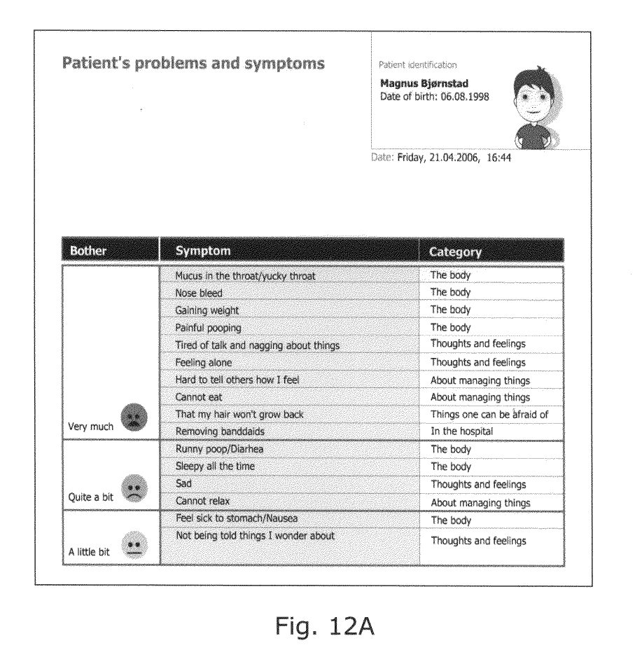

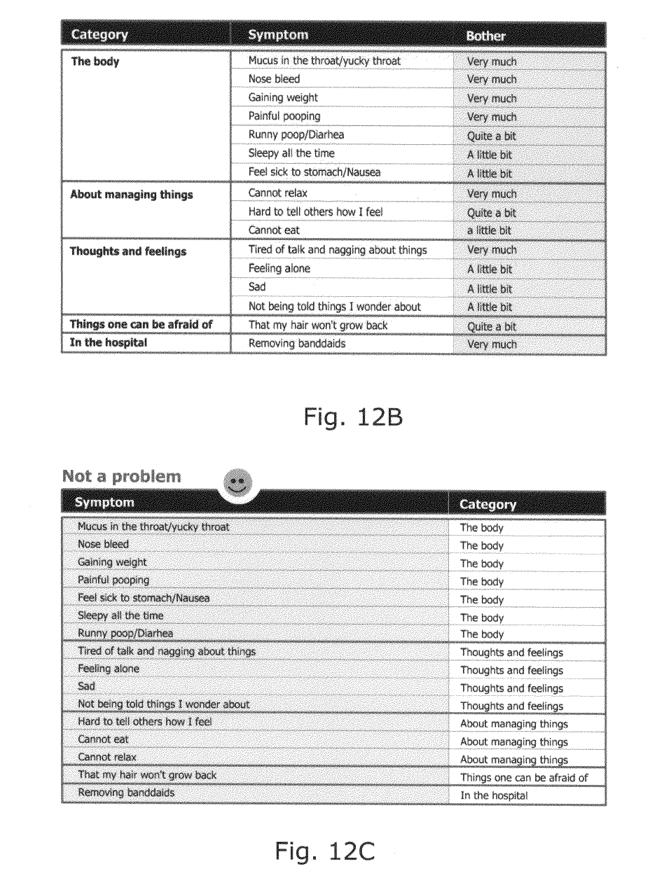

After child responses has been collected and registered, the report generator software can generate and print or send reports mapping the child's symptoms and problems. The report generator according to the exemplary embodiment can present reports in different layouts as illustrated in FIGS. 12A-C, all of which contain entries of corresponding categories, symptoms and problems, and response. In the report of FIG. 12A, the entries are ordered after relevancy as experienced by the child, in that the symptoms and problems which the child considers worst or most bothersome are put highest on the list. Thereby, it is easy for a caretaker to quickly identify the symptoms and problems of highest priority to the child. In the report of FIG. 12B, the entries are ordered after categories, which provide a systematic and ordered mapping of the symptoms and problems. In the report of FIG. 12C, only symptoms and problems which where not relevant or which the child managed fine are included. This is an easy way for the caretaker to bring forward for praising and encouraging the child.

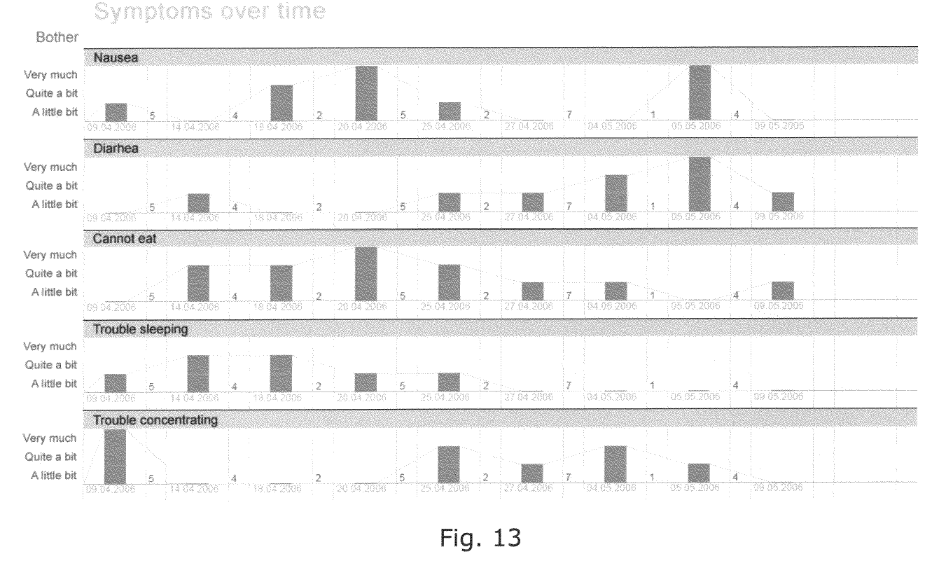

If the child completes the interactive questionnaire several times, the development may be illustrated in a trend report as illustrated in FIG. 13. Here, the relevancy of each symptom and problem is shown for each date the child completed the questionnaire, allowing the caretaker to follow the progress of the child.

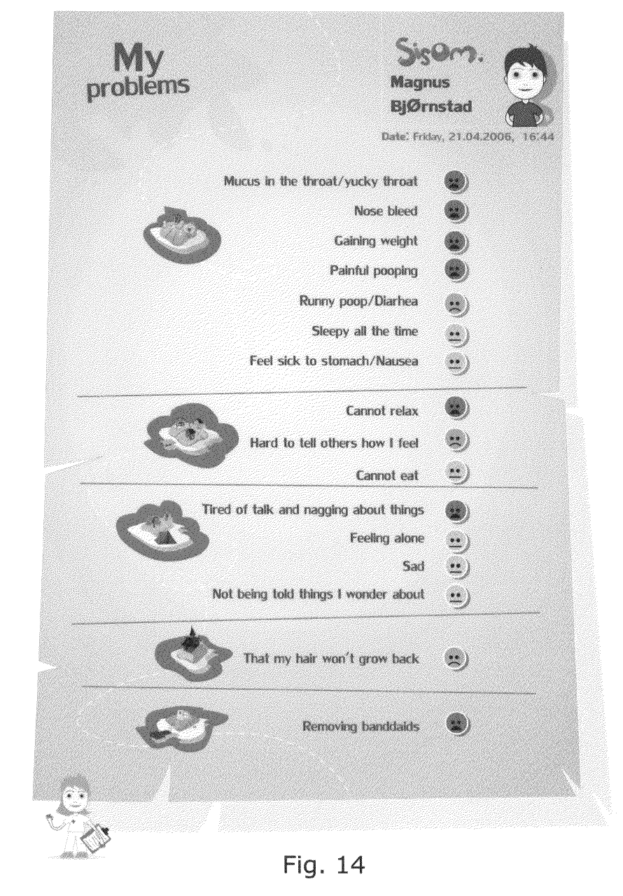

Finally, the report generator described here can also generate a special report to the child, an example of such a report is shown in FIG. 14. This report makes use of graphical illustrations to a much higher degree so that the child easily understands and remembers the symptoms and problems presented to him/her. This report can serve both as a prize for completing the questionnaire and as a communication tool for the child.

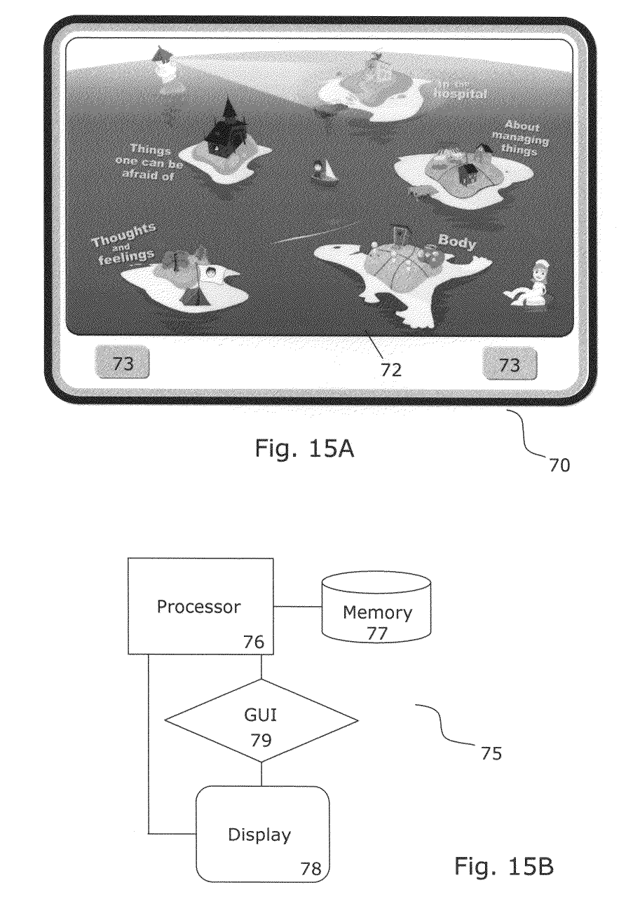

FIG. 15A shows an exemplary embodiment of the device according to the invention, where the device is contained in a portable unit 70 with a display 72 and a number of keys 73 for control and navigation. The display is a touch sensitive display consisting of a touch sensitive overlay on a flat panel display such as a liquid crystal display. The touch sensitive overlay may be pressure-sensitive (resistive), electrically-sensitive (capacitive), acoustically-sensitive (SAW—surface acoustic wave) or photo-sensitive (infra-red) in order to be able to register the position of an object touching the display, e.g. a pen or a finger. The touch sensitive display is thereby both a display and a pointing device.

In an alternative embodiment, the display can be a standard flat panel display and the pointing device can be a cursor as known from standard PC operating systems controlled by a mouse, joystick, eye-tracking device etc.

FIG. 15B illustrates a typical hardware layout for an embodiment 75 of the device according to the first aspect. The device may be a PC such as a laptop, a PDA, a mobile phone, a multimedia player, or any other device capable of executing such interactive software. Any such device is a complicated apparatus whose detailed design and performance is not the subject of this description. Common features however are an electronic processor 76 such as a CPU, a memory 77, e.g. hard disk drive, flash memory, RAM, optical storage etc., and a display 78 such as an LCD display for presenting graphics. The memory stores the interactive questionnaire software and any responses selected by the user whereas the processor manages the execution of the software.

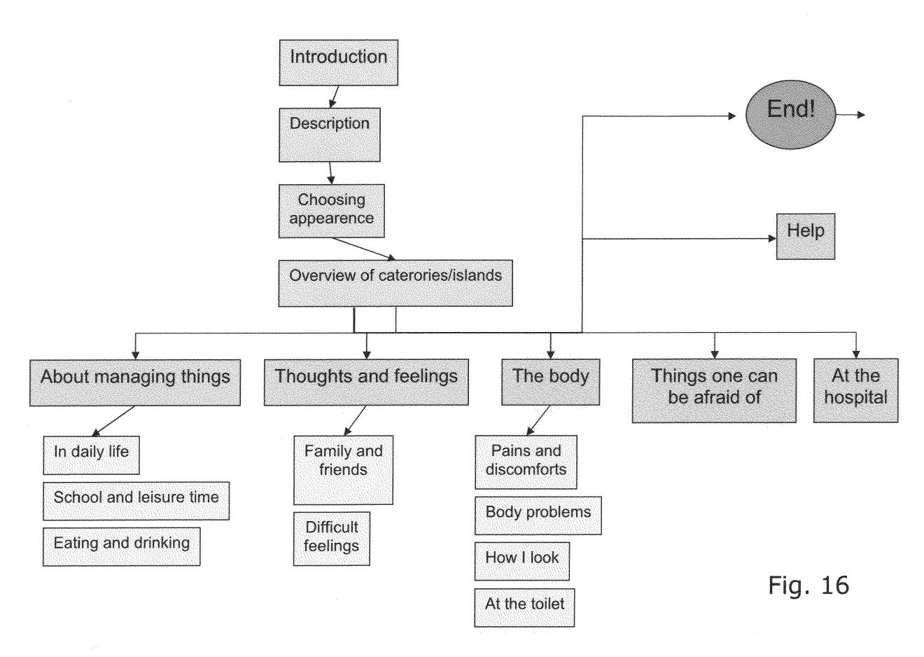

FIG. 16 illustrates the layout of an exemplary embodiment of the interactive questionnaire according to the second aspect. The structure is easily recognized from the description in relation to FIGS. 1-9. Navigating in the storyline is performed through the use of hyperlinks formed in relation to objects and illustrations.

The invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A device for mapping health related symptoms and problems, the device comprising:
a memory;
an electronic processor;
a display;
a graphical user interface (GUI);
a pointing device for user interaction via the GUI;
software implementing an interactive questionnaire for presenting health related symptoms and problems to a user and registering the user's response via the GUI,
the interactive questionnaire being configured to graphically present and perform a main character and a storyline, wherein the storyline consists of a number of categories related to at least physical health, mental health, and everyday life, and wherein the main character can be controlled to go through the storyline by the user;
software implementing a report generator for generating a report that maps health related symptoms and problems based on the response from the user.

2. The device according to claim 1, wherein the interactive questionnaire is further configured to:
graphically present, in each category, the main character in one or more scenes, each scene presenting a number of potential health related symptoms and/or problems;
provide a graphical object for each potential health related symptom or problem;
for each said graphical object, provide a link to an explanatory illustration of the symptom or problem and a response option allowing the user to select a degree to which the symptom or problem is relevant; and
register each selection made by the user.

3. The device according to claim 1, wherein the report generator is configured to, present the registered responses in one or more reports listing connected categories, symptoms and/or problems, and user responses.

4. The device according to claim 1, wherein the display and the pointing device are provided by a touch sensitive display.

5. The device according to claim 1, wherein the device further comprises a battery rendering the device fully portable.

6. The device according to claim 1, wherein the memory and electronic processor can store and recall previous responses from the user, and wherein the report generator can generate a report of the development of the user's responses to symptoms and/or problems over time.

7. A software program for mapping health related symptoms and problems, to be executed on an electronic processing device with a display, a pointing device and a graphical user interface (GUI), the software program comprising:
an interactive questionnaire for presenting health related symptoms and problems to a user and registering the user's response via the GUI,
the interactive questionnaire being configured to graphically present and perform a main character and a storyline, wherein the storyline consists of a number of categories related to at least physical health, mental health, and everyday life, and wherein the main character can be controlled to go through the storyline by the user;
a report generator for generating a report that maps health related symptoms and problems based on the response from the user.

8. The software program according to claim 7, wherein the interactive questionnaire is further configured to:
graphically present, in each category, the main character in one or more scenes, each scene presenting a number of potential health related symptoms and/or problems;
provide a graphical object for each potential health related symptom or problem;
for each said graphical object, provide a link to an explanatory illustration of the symptom or problem and a response option allowing the user to select a degree to which the symptom or problem is relevant; and
register each selection made by the user.

9. The software program according to claim 7, wherein the report generator is configured to present the registered responses in a report, the report lists connected categories, symptoms and/or problems, and user responses.

10. A method for mapping health related symptoms and problems, the method is to be carried out on an electronic processing device with a display, a pointing device and a graphical user interface (GUI), the method comprising the steps of:
graphically presenting and performing a main character and a storyline consisting of a number of categories related to at least physical health, mental health, and everyday life, wherein the main character is controlled to go through the storyline by a user via the GUI;
presenting potential health related symptoms and problems in each category and allowing the user to respond the presented symptoms and problems via the GUI; and
presenting the response from the user to the presented symptoms and problems in a report, the report listing connected categories, symptoms and/or problems, and response.

11. The method according to claim 10, further comprising the steps of:
in each category, graphically presenting the main character in one or more scenes, each scene presenting a number of potential health related symptoms and/or problems;
for each potential health related symptom or problem, presenting a graphical object for the symptom or problem;
linking each graphical object to an explanatory illustration of the symptom or problem and a response option that allows the user to respond with a degree to which the symptom or problem is relevant.
